(19) United States
(12) Patent Application Publication
(10) Pub. No.: US 2009/0140086 A1
(43) Pub. Date: Jun. 4, 2009

(54) Method and Apparatus for Deforming Media

(75) Inventor: Leroy Thiel, Lincoln, NE (US)

Correspondence Address: FITCH EVEN TABIN AND FLANNERY, 120 SOUTH LASALLE STREET, SUITE 1600, CHICAGO, IL, 60603-3406, US

(73) Assignee: Data Security, Inc., Lincoln, NE (US)

(21) Appl. No.: 11/950,145

(22) Filed: Dec. 4, 2007

(51) Int. Cl. B02C 13/22

(52) U.S. Cl. 241/27; 241/259.1

(57) ABSTRACT

A system and method for deforming and puncturing magnetic storage media includes one or more pivot arms that support one or more rotationally driven rotatable members bearing multiple deforming members or punch points. The punch points impact the media, producing the deformation, while the rotational forces push the media through the system, and the pivot arms adapt to media characteristics and widths to protect against jams. The puncturing force may be adjustable.

### FIELD OF THE INVENTION

The invention relates generally to the mechanical arts and more specifically to an apparatus and method for deforming media to mark the media and/or render the media unusable.

### BACKGROUND

Destruction of information magnetically encoded onto magnetic storage media is often desired, for example, when the media becomes obsolete but the information is of a sensitive or classified nature. Computer systems provide file delete functions; however, many software products are able to reverse the process and restore the encoded information. Software overwrite methods magnetically alter the information by overwriting the encoded information, but such a process can be slow and reversible. Also, should a computer hard drive crash and stop functioning properly, software overwriting becomes useless.

It is also known to erase magnetic media through bulk degaussing, which has been employed in different forms to alter the magnetic information on the storage media. Electromagnets and windings that produce strong magnetic fields can erase information from computer hard drives but require high input energy levels or long times to store the energy needed to produce such fields. Permanent magnet structures have also been used for erasing magnetic information, but permanent magnet structures able to produce the strong magnetic fields required to erase information tend to be large and heavy. Bulk degaussing methods also typically leave no outward physical evidence of media erasure.

Another known method for protecting stored information is to alter the disk that stores the information in configuration or shape, such as by pulverization into fine particles or compaction by a mechanical press. The process of shredding a complete hard drive into many small pieces requires very high contact loads between the cutter teeth and the hard drive. To produce these large forces, the input line energy levels tend to be very high and the overall physical size of the equipment is extremely large. There can also be other hazards associated with the disposal of the small partials produced by the process.

The deforming of storage media has also been employed in several different forms. It is known, for example, to use a conical shaped crushing head that aligns to a conical-shaped receiving plate. The crushing head moves in a direction that is perpendicular to the surface of the storage media to engage and deform the media. It is also known to use a multi pronged head that moves in a path perpendicular to the surface of the storage media to deform the media. Such approaches require the operator to properly locate the magnetic storage platters inside a hard drive and orient them properly prior to destruction. The use of such physical deforming devices during a security emergency may lead to a greater possibility of operator errors.

Another approach to physically deforming the media includes using a wedge shaped member that moves in a path perpendicular to the magnetic storage media surface that it contacts. The length of the wedge shaped member is as long as the longest length of the media that it deforms. This approach overcomes the issues associated with the proper orientation of the media but inherently produces a slow cycle time for processing the media. Accordingly, there is a need for a deforming system that eliminates operator errors, is not large in size, is portable, and has a fast cycle time.

Another concern includes marking media with sensitive information that has been erased or otherwise rendered non-sensitive. Such markings are often applied manually as the sensitive material is erased or damaged. For dealing with destruction of vast quantities of sensitive information, fast and automated methods are preferred. For example, the term “unclassified” might be printed on magnetic storage media automatically as it exits a conveyorized bulk degausser. The marking apparatus could be programmable to include such information as a date, an operator name, and batch information. Such printing is routine in the mass production of goods, and can be accomplished by non-contact means on a variety of materials and surface shapes. In mass production, factors like size, shape, and material can be predetermined precisely and made to remain stable for large batches of product, allowing details like ink type and print head position to be optimized for the process. In contrast, an automated bulk degaussing system suited to information destruction of massive media quantities may treat a mixed stream of such media. Even if limited to a constant form factor such as 3.5 inch (8.89 cm) hard disk drives, the media stream can include a great deal of variation not limited to color, material, shape, and texture that confounds mass printing methods. A system providing flexible marking means for magnetic storage media that contains variable configurations is therefore needed in the destruction of large volumes of sensitive information.

### BRIEF DESCRIPTION OF DRAWINGS

FIG. 1 is a perspective view of an embodiment of a deforming device.

FIG. 2 is a plan view of the deforming device of FIG. 1 together with an example power transmission and driving apparatus.

FIG. 3 is a partial side cross sectional view of the deforming device of FIG. 1.

FIG. 4 is a partial side cross sectional view of the deforming device of FIG. 1 with a magnetic medium disposed within the device.

FIG. 5 is a side view of a portion of a deforming device in accordance with various embodiments.

FIG. 6 is a partial side cross sectional view of the deforming device of FIG. 1 with an object disposed within the device.

FIG. 7 is a partial side cross sectional view of the deforming device of FIG. 1 with an object disposed within the device.

FIG. 8 is a side view of a portion of a deforming device in accordance with various embodiments.

FIG. 9 is a side view of a portion of a deforming device in accordance with various embodiments.

FIG. 10 is a side view of two example rotatable members spaced in accordance with various embodiments.

FIG. 11 is a side view of two example rotatable members spaced in accordance with various embodiments.

FIG. 12 comprises side and cross-sectional views of an example deforming member.

FIG. 13 comprises side and cross-sectional views of an example deforming member.

FIG. 14 comprises side and cross-sectional views of an example deforming member.

FIG. 15 a partial side cross-sectional view of an embodiment of a deforming device.

FIG. 16 a partial side cross-sectional view of an embodiment of a deforming device.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the invention. Also, common but well-understood elements that are useful or necessary in a commercially feasible embodiment are often not depicted in order to facilitate a less obstructed view of these various embodiments of the invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

Generally speaking, pursuant to these various embodiments, an apparatus for deforming media includes a media conveyance path, a pivot arm, and a biasing system operatively connected to the pivot arm to bias the pivot arm toward the media conveyance path. At least one rotatable member is rotatably secured to the pivot arm, and at least one deforming member is secured to the rotatable member. Accordingly, a medium may be accepted into the media conveyance path wherein the medium is engaged by a plurality of deforming members rotating on the rotatable member. A deforming force is thereby applied to the medium through the deforming members via the biasing system. The rotating members may be moved away from the medium when the deforming members encounter a force from the medium that is larger than the deforming force.

So configured, a magnetic medium may be punctured or otherwise deformed, thereby rending the information stored thereon at least partially unreadable. The punctured or deformed nature of the medium may also serve as an indication that the medium has been at least partially erased or otherwise rendered unreadable. Moreover, the biasing member in certain embodiments allows for retraction of the deforming and rotating members to reduce jamming.

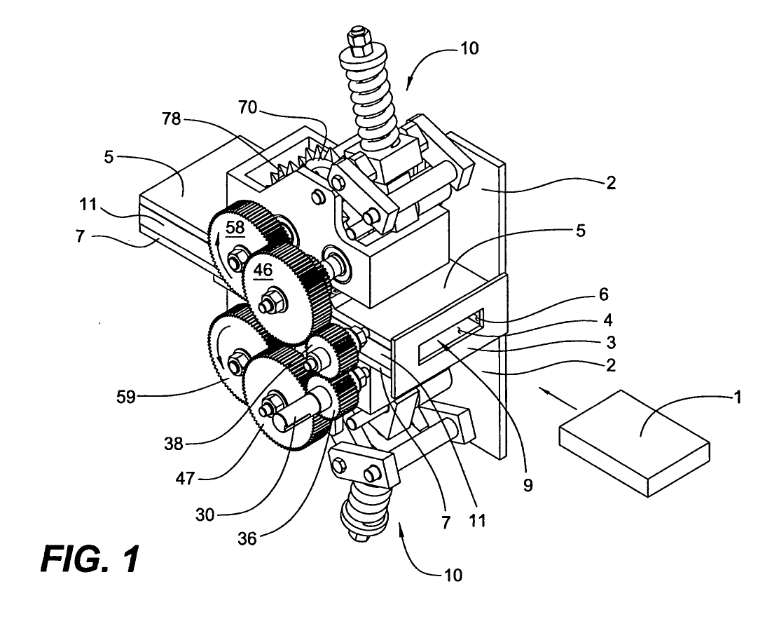

These and other benefits may become clearer upon making a thorough review and study of the following detailed description. Referring now to the drawings, and in particular to FIGS. 1-4, an example apparatus for deforming media includes a media conveyance path 9, a pivot arm 66, and a biasing system 10 operatively connected to the pivot arm 66 that biases the pivot arm 66 toward the media conveyance path 9. At least one rotatable member 70 is rotatably secured to the pivot arm 66, and at least one deforming member, such as punch point 78, is secured to the rotatable members 70 such that the deforming members are biased toward the media conveyance path 9 to at least partially deform a medium 1 passing through the media conveyance path 9. A driving apparatus such as electric motor 20 can be operatively connected to the rotatable member 70.

With reference to FIG. 1, an opening or aperture 4 allows access of the magnetic storage medium 1 to the media conveyance path 9. The aperture 4 is defined by a media restrictor plate 3 through which a medium 1 to be deformed is passed. The aperture 4 of the media restrictor plate 3 defines the allowable cross-sectional area of the magnetic storage media 1 that can pass through the media conveyance path 9. The height and width of the aperture 4 of the media restrictor plate 3 is preferably slightly larger than the size of the magnetic storage medium 1. The media passageway top surface 5, media passageway bottom surface 7, and media passageway side surfaces 6 and 11 define the media conveyance path 9 through the apparatus and are spaced to be slightly larger that the medium 1 to be deformed. The height and width of the media conveyance path 9 is preferably slightly larger than the height and width of the aperture 4.

The magnetic storage medium 1 contacts the media passageway bottom surface 7, which can be oriented at any angle from horizontal to vertical. Preferably, the media passageway bottom surface 7 slants at an angle of 30° downward from a point where the magnetic storage medium 1 passes through the media restrictor plate 3 to a point where the magnetic storage medium 1 exits the media conveyance path 9 at the opposing end, thus allowing for gravity feed of the medium 1. The media passageway side surface 6 is attached to the chassis side 2. The chassis side 2 is a rigid frame member that provides a common ground reference and support for many components of the apparatus.

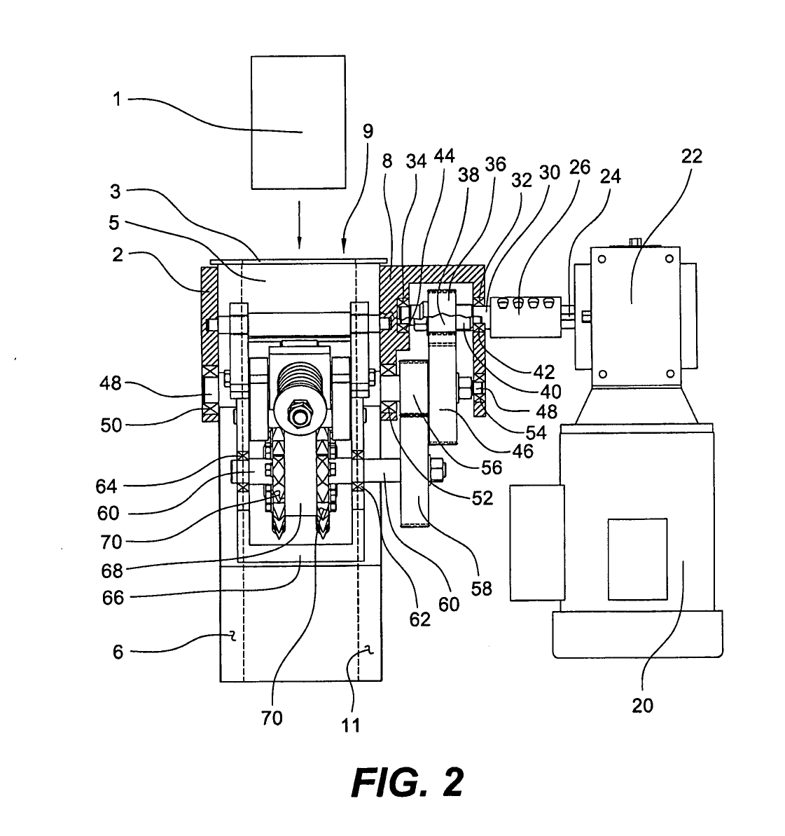

FIG. 2 illustrates parts associated with an example power transmission and driving apparatus to produce the rotational motion of the rotatable members 70. By one approach, an electric motor 20 converts electrical power into rotational motion. The electric motor 20 is rigidly attached to a speed reducer 22. The input energy to electrical motor 20 produces rotational motion and torque that is transmitted to the speed reducer 22. Depending upon the horsepower, shaft rotations per minute (“RPM”) speed of the electric motor 20, and the size of the rotatable members 70 necessary for a given application, the speed reducer 22 is preferably configured to produce an output shaft speed greater than 10 RPM and a torque greater than 10 ft-lbs (1.38 kg-m), although other configurations are possible depending on the application of the device. The resulting rotational motion of the speed reducer 22 is transmitted to the speed reducer output shaft 24. Any appropriate attachment means such as bolts or shaft keys are used to firmly secure speed reducer output shaft 24 to a shaft coupling 26. Keys, bolts, or other suitable means are used to rigidly attach the shaft coupling 26 to a gear box input shaft 30. The input shaft 30 receives energy approximately equal to the amount present in the speed reducer output shaft 24.

By another approach, the driving apparatus may include a crank handle (not shown). The crank handle, for example, may include a lever arm, or crank handle offset, that attaches to a hand grip member. The lever arm length, or crank handle offset, could be changed by one skilled in the art to match the input torque requirements to the speed reducer 22 or other coupling to the rotatable members 70 to operate the mechanism. Such an approach may be useful in an emergency situation where power to the apparatus is lost. Other example approaches to the driving apparatus for providing input energy to the rotatable members 70 could be in the form of a pneumatic or hydraulic driven motor or an internal combustion engine, although other approaches may be envisioned.

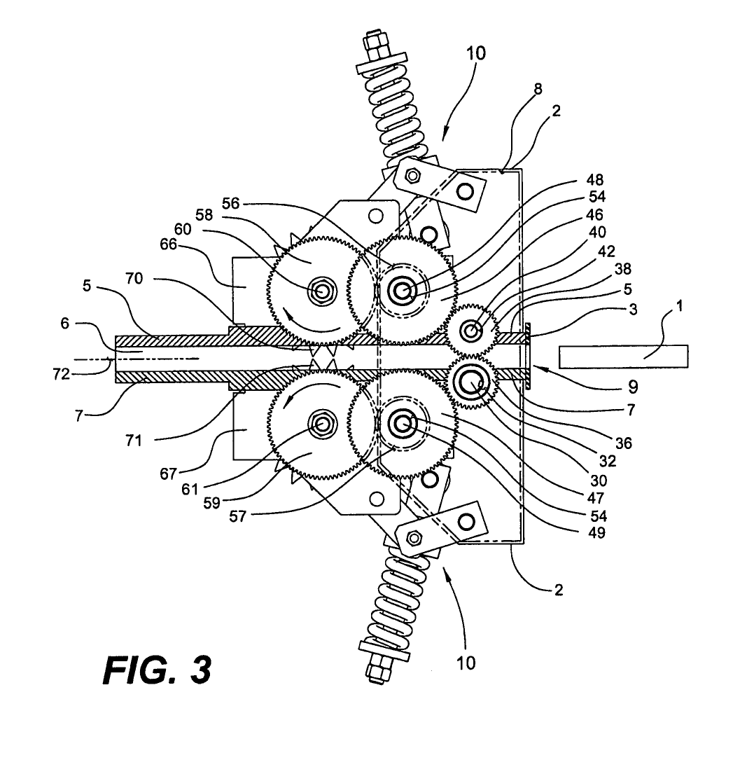

With reference to FIGS. 2 and 3, the gear box housing 8 is a rigid frame support member that contains components of the power transmission drive between input shaft 30 (connected to the driving apparatus, here electric motor 20) and rotatable members 70. The gear box housing 8 is securely attached to the media passageway side surface 11 and to the chassis side 2. Bearings 32 and 34 support the gear box input shaft 30 at two points along its length and constrain it to rotational motion about its axis. Input shaft bearings 32 and 34 are securely seated in gear box housing 8. The input shaft 30 has a counterclockwise direction of rotation when viewed from the right hand side of FIG. 2. Bolts, keys, or other suitable attaching methods are used to firmly affix drive gear 36 to the input shaft 30 at a location that is between the input shaft bearings 32 and 34. The rotational motion and energy that the drive gear 36 receives is approximately equal to that of the input shaft 30. The drive gear 36 is in mesh contact with an idler gear 38, drawn partially cut away to reveal drive gear 36 behind it, and second stage gear 47. The energy from drive gear 36 is approximately evenly split between the idler gear 38 and second stage gear 47. The idler gear 38 takes on a clockwise direction of rotation. Any appropriate means such as bolts or keys may be used to rigidly attach the idler gear 38, shown partially cut away, to the idler gear shaft 40, which is also drawn partially cut away. Shaft bearings 42 and 44 support the idler gear shaft 40 at each end and constrain it to rotational motion about its axis. Shaft bearings 42 and 44 are firmly mounted in gear box housing 8.

A second stage gear 46 is in mesh contact with the idler gear 38. The rotational direction of the second stage gear 46 is reversed to counterclockwise, and the amount of rotational torque increases as according to the ratio of the second stage gear 46 to the idler gear 38. Keys, bolts, or other suitable holding means may be used to soundly affix the second stage gear 46 to an arm pivot shaft 48. Three shaft bearings 50, 52, and 54 limit the arm pivot shaft 48 to rotational motion about its axis. One shaft bearing 50 is firmly seated in the chassis side 2, and the other shaft bearings 52 and 54 are firmly held in the gear box housing 8. The smaller second stage gear 56 is positioned and firmly attached with any suitable means to the arm pivot shaft 48 that is coaxial with the larger second stage gear 46. The smaller second stage gear 56 receives energy approximately equal to that contained in the larger second stage gear 46 and moves in the same rotational direction. Second stage gears 46 and 56 are in a position on arm pivot shaft 48 that places their location between shaft bearings 52 and 54. The second stage gear 56 is located towards the inside of the mechanism relative to the larger second stage gear 46. Under certain geometry limiting constraints, the reverse positioning could be applied.

A punch drive gear 58 is in mesh contact with the smaller second stage gear 56. The punch drive gear 58 is reversed to clockwise and the amount of rotational torque increases according to the ratio of the punch drive gear 58 to the second stage gear 56. A suitable means such as shaft keys or bolts is used to firmly secure the punch drive gear 58 to a rotatable member shaft 60. Shaft bearings 62 and 64 restrict the rotatable member shaft 60 to rotational motion about its axis. The shaft bearings 62 and 64 are firmly constrained in the pivot arm 66. Shaft keys, bolts, or other appropriate holding means may be used to rigidly hold a rotatable member mount 68 to the rotatable member shaft 60. The rotatable member mount 68 has approximately the same torque and rotational direction as the punch drive gear 58. Bolts, rivets, or other suitable means may be used to affix one rotatable member 70 to each side of the rotatable member mount 68.

The number of rotatable members and spacing between them can be changed to meet the challenges associated with different magnetic storage media sizes. For example, if 1.8 inch (4.57 cm) hard drives or smaller micro drives are to be deformed, then three or more rotatable members 70 may be mounted along the rotatable member shaft 60 to ensure contact with the small 1.8 inch (4.57 cm) media traversing the pathway. If 5.25 inch (13.336 cm) hard drives are to be deformed, then only one rotatable member 70 is necessary per rotatable member shaft 60. Similarly, the internal construction of all magnetic storage media hard drives is not the same; for instance, the spindle motors that rotate the magnetic storage platters inside a hard drive are generally centered from side to side. Accordingly, two rotatable members 70 may cover the width of a 3.5 inch (8.89 cm) hard drive and still avoid the relatively dense hard drive spindle motor. The spacing of the rotatable members 70 may be configured as necessary. It is also realized that if large quantities of hard drives with steel covers is deformed, the rotatable member 70 can experience excess wear and need replacement periodically. Accordingly, a reusable type of holding device such as bolts for mounting rotatable member 70 may be used, although more permanent mounting means can be used as well.

With continuing reference to FIG. 3, the gear train of the input drive gear 36, the second stage gear 47, the arm pivot shaft 49, the second stage gear 57, the punch drive gear 59, and the rotatable member shaft 61 are nearly mirror images of the structures opposite a plane 72, including the power transmission aspects of the idler gear 38, the second stage gear 46, the arm pivot shaft 48, the second stage gear 56, the punch drive gear 58, and the rotatable member shaft 60. Only the shafts 30 and 40 and respective mounting bearings differ in this example embodiment. The mirror image extends to the reverse direction of rotation of respective gears and to the rotatable members 70 and 71, which are driven through the gear train.

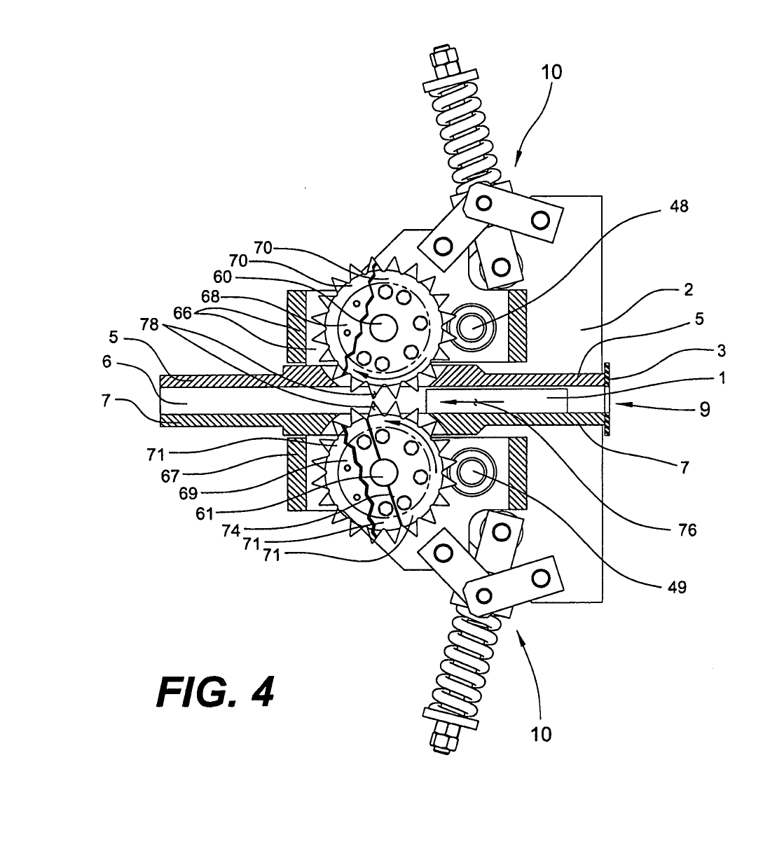

By one approach, with reference to FIG. 4, a rotatable member 71 may be split along a parting line 74 into two semicircular portions. A rotatable member 70, shown as a one piece circular member, or rotatable member 71 can be sectioned into one or more equal or unequal portions depending on design and maintenance requirements. The rotatable member 70 extends through a slot in the media passageway top surface 5 and into the media conveyance path 9. Likewise, the bottom rotatable member 71 extends through media passageway bottom surface 7 and into the media conveyance path 9. As the magnetic storage medium 1 travels in the direction of arrow 76, it will come into contact with the rotatable members 70 and 71. The clockwise rotational torque on the top rotatable member 70 and counterclockwise rotational torque on the bottom rotatable member 71 will cause the magnetic storage medium 1 to be pulled into and past the rotatable members 70 and 71. As the medium 1 passes between the rotatable members 70 and 71, the punch points 78 located on the outside periphery of rotatable member 70 and 71 will puncture the medium 1.

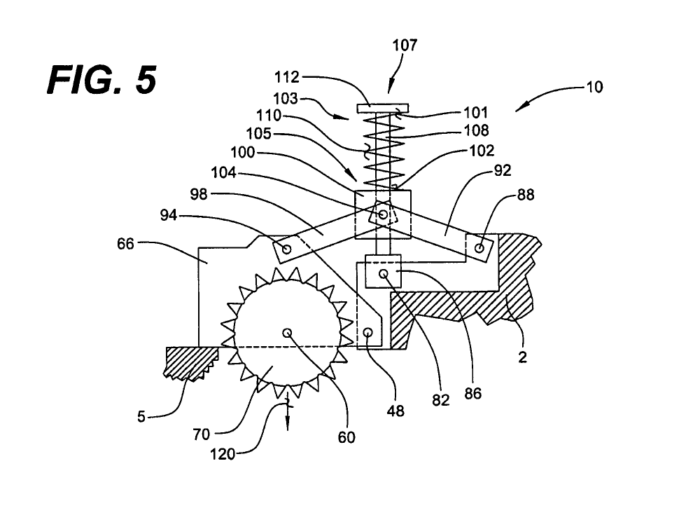

A biasing system 10 generates the force needed for the punch points 78 to puncture the medium 1, and FIG. 5 shows a simplified sketch of the example biasing system 10 illustrated in FIGS. 1-4. The biasing system 10 includes a compressed spring 110 having a first spring end 101 and a second spring end 102, wherein the compressed spring 110 is disposed on a spring guide assembly 107. The spring guide assembly 107 includes a spring guide 108 having a spring guide first end 103 disposed toward the first spring end 101 and a spring guide second end 105 disposed toward the second spring end 102. The spring guide assembly 107 also includes an adjustable spring retainer 112 secured to the spring guide first end 103 and a center pivot block 100 slidably engaging the spring guide 108 toward the spring guide second end 105 and the second spring end 102. A pivot pin 82 is rigidly fixed to the chassis side 2 and supports and restricts the motion of a spring guide mount 86 to pure rotational motion about the axis of the pivot pin 82. The spring guide 108 is rigidly attached to the spring guide mount 86 with a center pivot block 100 constraining it to limited rotational motion about the axis of the pivot pin 82.

The compression spring 110 slides over the spring guide 108, and the adjustable spring retainer 112 is adjustable along the length of the spring guide 108. The adjustable spring retainer 112 constrains the compression spring 110 in a compressed state and from sliding off the spring guide 108. Pivot pins 88 and 104 support the ground link 92. The first pivot pin 88 is firmly attached to the chassis side 2, and the second pivot pin 104 is rigidly attached to the center pivot block 100. The ground link 92 is restricted to rotational motion about the axes of the pivot pin 88. Pivot pins 94 and 104 support the pivot arm link 98. The first pivot pin 94 is soundly attached to the pivot arm 66. The pivot arm link 98 moves in with both linear and rotational motion when the linkage assembly moves. The configuration of the linkage assembly determines the motion of pivot arm link 98 and may be adjusted for a particular application. The arm pivot shaft 48 and media passageway top surface 5 both support and restrict the motion of the pivot arm 66 to pure rotational motion about the axis of the arm pivot shaft 48. Bearings in the pivot arm 66 support the rotatable member shaft 60, thereby allowing it to rotate about its axial centerline. The rotatable member 70 is firmly attached to the rotatable member shaft 60 and rotates in unison with it. So configured, the pivot arm 66 is rotatably secured to the first pivot arm link 98 and the chassis 2, which at least partially supports the apparatus; the first pivot arm link 98 is rotatably secured to the center pivot block 100 and a second pivot arm link 92; and the spring guide assembly 107 and the second pivot arm link 92 are rotatably secured to the chassis 2 such that the compressed spring 110 biases the pivot arm 66 toward the media conveyance path 9.

Accordingly, when compressed, the spring 110 exerts a force on the center pivot block 100 in the direction of the spring axial centerline. The center pivot block 100 transfers this force to the pivot pin 104, which in turn transfers the force to the pivot arm links 92 and 98. The first pivot arm link 98 transfers the force of the spring 110 to the pivot pin 94, which in turn creates a rotational moment on the pivot arm 66 about the centerline of the arm pivot shaft 48. The rotational force moment of the pivot arm 66 applies a vector summed force in the general direction of force arrow 120. This vector summed force 120 is transferred from the pivot arm 66 to the rotatable member shaft 60, which applies this same force to the rotatable member 70. The ground link 92 provides the required opposing force on the pivot pin 104 to keep the mechanism in a stable condition.

Other configurations of this mechanism are possible to meet other conditions. For example, if one were to reduce the spring rate of the spring 110, then the pivot pin 94 may be moved farther away from the arm pivot shaft 48 to a location that would provide a larger moment arm to provide an equivalent rotational force moment on the pivot arm 66. In another example, the pivot pin 82 may be moved away from the arm pivot shaft 48. In this condition, the ground link 92 and/or the pivot arm link 98 may be made longer, and the location of the pivot pin 88 may be moved (or some combination of all three) to obtain a necessary rotational torque on the pivot arm 66 for a given application. One could also keep the location of the arm pivot shaft 48 fixed and change the relative locations or lengths of the rotatable member shaft 60, pivot pin 82, pivot pin 88, pivot pin 94, pivot pin 104, ground link 92, or pivot arm link 98 to produce a wide variety of mechanism operating conditions. Accordingly, the mechanism can be configured to optimize its performance for the media to be deformed.

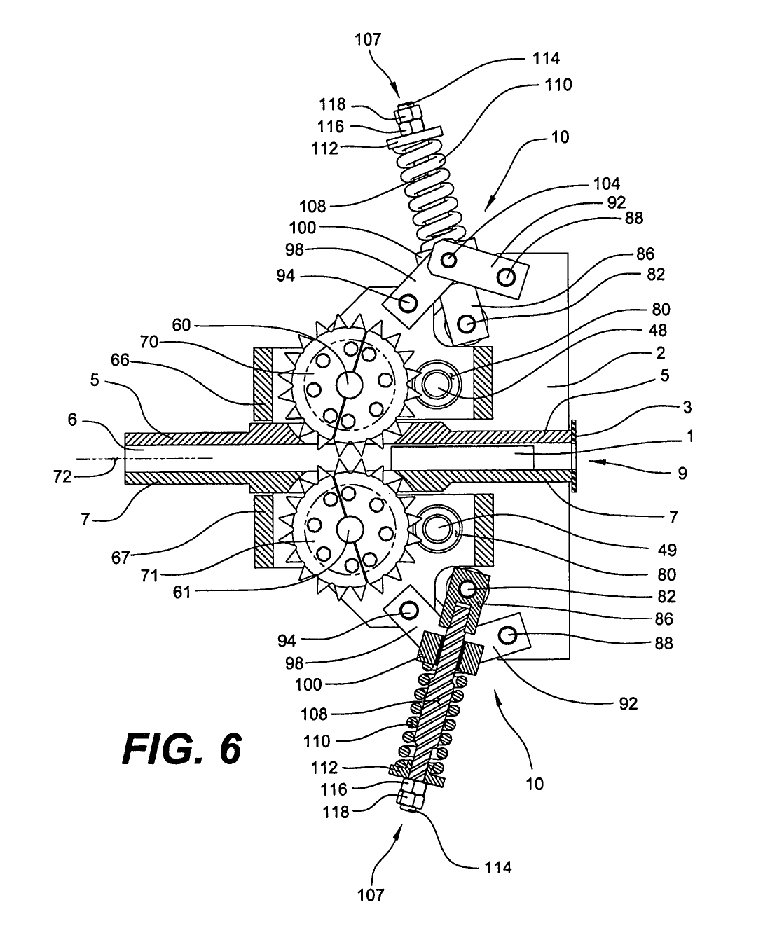

With reference to FIG. 6, two biasing systems are shown that in all aspects are identical in size and configuration and are mirrored about line 72. The biasing systems' configurations and sizes can be different to tailor the mechanism to a specific operating condition. Compression springs 110 are axially aligned with and freely slide over the spring guides 108. Spring retainers 112 in part provide a means for both preloading and constraining the compression springs 110 in place. Each spring retainer 112 contains an internal clearance hole slightly larger in diameter than the threaded portions 114 at the end of the spring guides 108. Adjustment nuts 116 thread onto the threaded portions 114 and contact the sides of spring retainers 112 to compress and preload the compression springs 110. The distance that the adjustment nut 116 is threaded onto the threaded portion 114 directly affects to the amount of force that the rotatable members 70 and 71 apply to the magnetic storage medium 1. In the illustrated example, a 5 inch (12.7 cm) long free length spring is compressed ¾ inch (1.9 cm) through the adjustment of the adjustment nut 116 to reach a predetermined preload force. Other spring diameters and lengths may be used. After the adjustment nuts 116 preload the compression springs 110 to the desired condition, lock nuts 118 are threaded onto the threaded portions 114 and tightened against the adjustment nuts 116.

The forces generated by the compression springs 110 are transferred through the linkages and produce counter rotational moments of the pivot arms 66 and 67 about the pivot arm shafts 48 and 49 respectively. The bearings 80 are pressed into the pivot arms 66 and 67, and slide over the pivot arm shafts 48 and 49, which constrain the pivot arms 66 and 67 to rotation only. The media passageway top surface 5 and media passageway bottom surface 7 limit the rotational motion in the pivot arms 66 and 67 respectfully. Accordingly, the compression springs 110 are compressed to a predetermined preload value to ensure that an ordinary hard drive or other magnetic storage media will be punctured as a result of the force with which the punch points 78 engage the media.

So configured, the deforming apparatus may operate according to the following example method. A medium 1 is accepted into the media conveyance path 9 wherein the medium 9 is engaged by a plurality of deforming members, such as punch points 98, rotating on at least one rotating member 70. The apparatus applies a deforming force to the medium 1 through the deforming members via the biasing system 10. The apparatus allows movement of at least one of the rotating members 70 away from the medium 1 when the deforming members engage the medium and encounter an engaging force higher than the deforming force. By one approach, the biasing system 10 includes an adjustable compressed spring guide assembly 107 such that the deforming force is adjustable for a user.

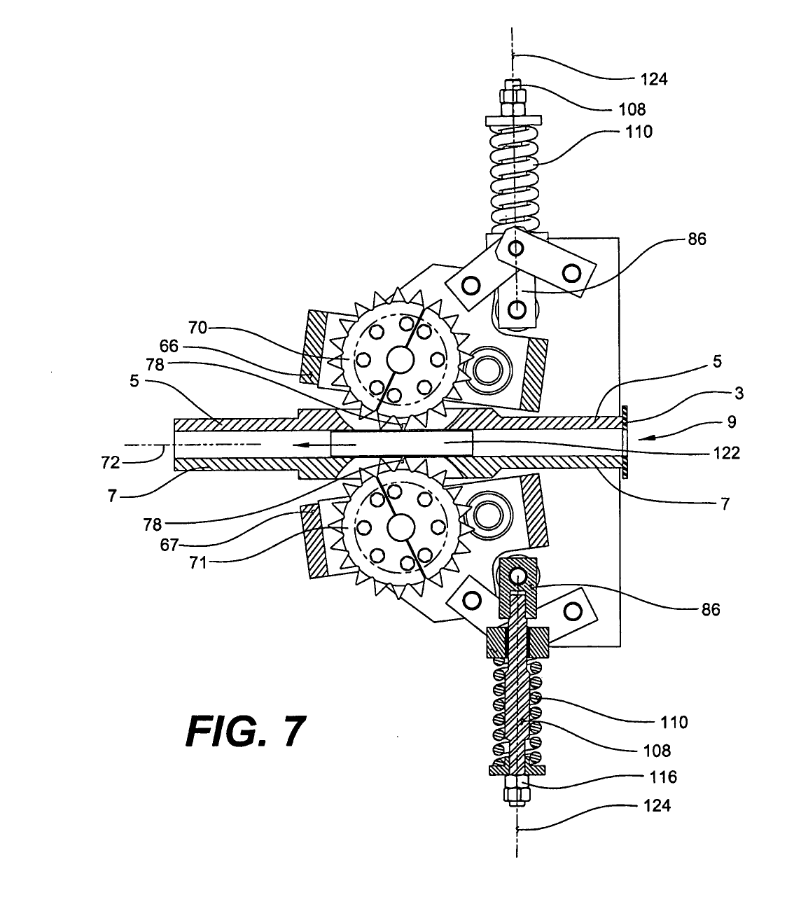

Referring to FIG. 7, the ability to move the rotating member 70 away from the medium 1 will be described. For example, a dense and incompressible object 122 may be placed into the media conveyance path 9 and brought into contact with the punch points 78 of the rotatable members 70 and 71. When the object 122 provides an opposing reaction force greater than the puncturing force of the punch points 78, the pivot arms 66 and 67 will rotate to positions where compression springs 110 produce a higher net reaction force and the opposing reaction forces between the object 122 and the rotatable members 70 and 71 reach a state of equilibrium. In practice, the springs 110 can be differentially preloaded to approximately compensate for the weight of the mechanism plus that expected for the medium 1, for example, through an extra partial turn tightening the lower of adjustment nuts 116. In practice, the frictional force of the punch points 78 acting on a typical abusive object 122 combined with the torque imparted to either of the rotatable members 70 or 71 through the drive train will overcome the friction between the object 122 and the top surface 5 or the bottom surface 7 to eject the object 122 and avoid a jam.

So configured, jam conditions that may occur should the pivot arms 66 and 67 be fixed and not able to move away from the object 122, thereby potentially overloading the electric motor 20, may be avoided. A motor stall caused by a component failure is still possible, and therefore, conventional overload protection may still be provided for the motor.

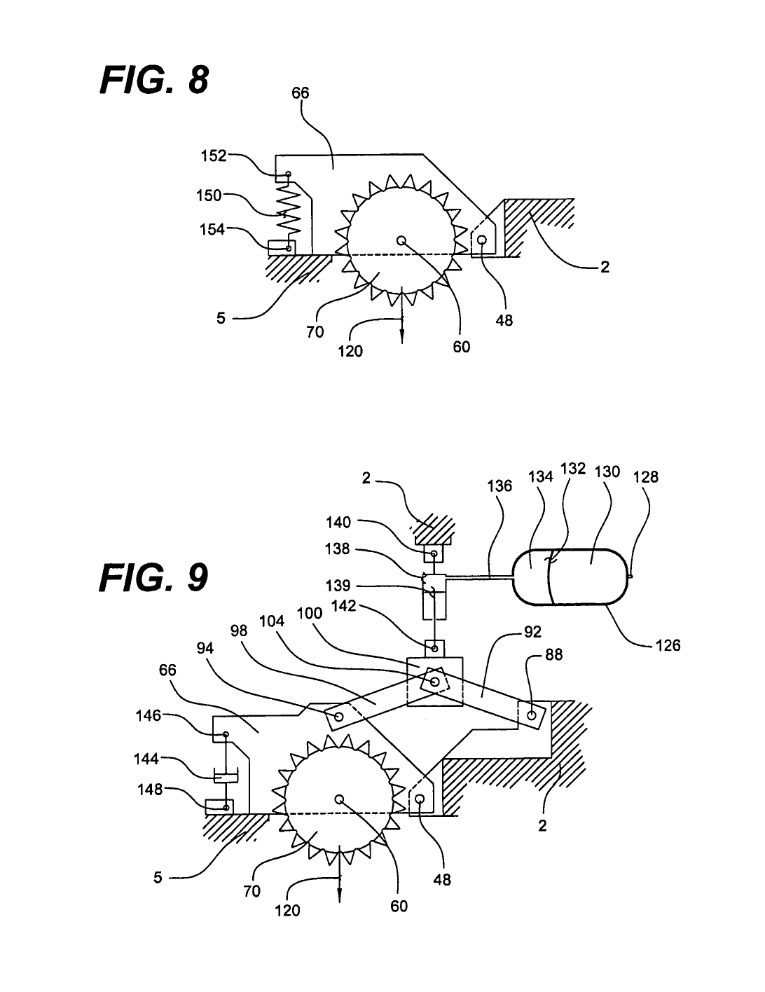

By another approach, the biasing system 10 may utilize other types of springs to bias the pivot arm 66. For example, and with reference to FIG. 8, an extension spring 150 may be operatively connected to the pivot arm 66 at a first point 152 and to the chassis 2 and/or the media passageway top surface 5 at a second point 154. If the distance between the connection points 152 and 154 is longer than the natural free length of the spring 150, then the spring 150 can be elongated to attach it and create a spring preload condition to produce a counterclockwise moment in pivot arm 66. This rotational torque in pivot arm 66 causes the rotatable member 70 to produce a force in the direction of arrow 120 that will puncture a hard drive beneath it. Other spring types such as torsion springs or leaf springs could also be used.

By yet another approach, the biasing system may use mechanical energy storage devices other than springs such as a hydraulic system. With reference to FIG. 9, an example hydraulic system will be described. The example hydraulic system includes a tank 126 containing a fluid in a volume 134 such that the pressure of the fluid is adjustable, and wherein the tank 126 is in fluid communication with a piston 139 operatively secured to a pivot block 100. The pivot block 100 is rotatably secured to a first pivot arm link 98 and a second pivot arm link 92. The second pivot arm link 92 is rotatably secured to the chassis 2, and the first pivot arm link 98 is rotatably connected to the pivot arm 66 such that the hydraulic system biases the pivot arm 66 toward the media conveyance path 9.

One way to control the fluid pressure is through use of an inlet valve 128 allows a compressible pneumatic gas such as air, nitrogen, or other suitable gas to be pumped under pressure into a volume 130 and held there without escaping from the tank 126. A second volume 134 is filled with the non-compressible hydraulic fluid that extends through a pipe 136 and into a cylinder 138 enclosing the piston 139. The cylinder 138 is rotatably connected to a secure structure such as the chassis 2 via a pivot pin 140. The piston 139 is confined to linear travel within a volume defined by cylinder 138 at one end and at the other end to the center pivot block 100 via pivot pin 142. The tank 126 can take on many different forms. The compressible gas in the volume 130, when placed under pressure, will transfer that same pressure through a flexible bladder 132 and to the non-compressible fluid in volume 134. The fluid in the volume 134 will then be pushed through the pipe 136 into the cylinder 138 and against the piston 139 causing a force on the center pivot block 100 in the direction of the arrow 120. Alternatively, the pressure of the fluid in volume 134 may be controlled by any known means. This same force will be transmitted through the pivot pin 104, pivot arm link 98, and pivot pin 94 to the pivot arm 66. This force will cause a counterclockwise moment on the pivot arm 66 about the pivot arm shaft 48 thereby rotating the pivot arm 66 until it comes into contact with media passageway top surface 5. The moment on the pivot arm 66 will induce a force on the rotatable member shaft 60 in the direction of the arrow 120. The rotatable member 70 is soundly attached to rotatable member shaft 60 and receives this same force and transmits it to the magnetic storage medium 1 during operation.

By another approach, a pneumatic system may be used as a biasing system whereby the pneumatic gas in the volume 130 works directly against the cylinder 138 to bias the pivot arm 66. Other hydraulic and pneumatic components that one skilled in the art would include in such a commercial system are not illustrated or described here. It is also possible to use some combination of springs, hydraulic fluids, or pneumatic gases for the biasing systems. Other example means of energy storage or potential that may be incorporated into the biasing systems include heavy weights, lever arms, and various types of motors or other apparatuses that are able to store mechanical or electrical energy.

Movement of the pivot arm 66 away from and then quickly toward the media passageway top surface 5 during the passage of material through the media conveyance path may cause undesired vibration and noise. The vibration and noise, however, can be reduced with the implementation of a shock absorbing device. For example, a shock absorber 144 of a common hydraulic shock absorbing type is operatively connected to the pivot arm 66 at a first point 146 and to the chassis 2 through the media passageway top surface 5 at a second point 148. During an overload operating condition, the pivot arm 66 will move away from the media passageway top surface 5. After the overload operating condition has passed, the pivot arm 66 will begin to rotate in a counterclockwise direction. If the size and load ratings of the shock absorber 144 are matched to the biasing system, the shock absorber 144 can reduce the angular velocity of the pivot arm 66 to a desired value. The shock absorber 144 can come in many different forms such as hydraulic, hydraulic/spring combinations, metal spring, air spring, open and closed cell foam, rubber, or any other form of a semi-elastic material.

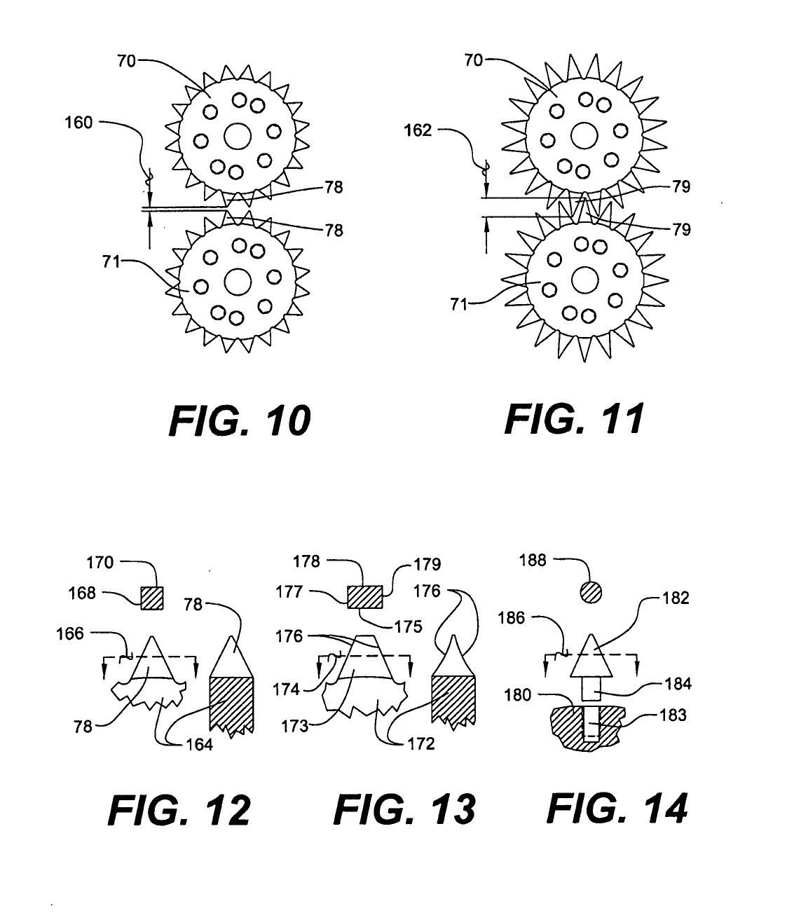

Various configurations of deforming members or punch points will be described with reference to FIGS. 10-14. FIG. 10 illustrates an example configuration where the distance between the rotatable members 70 and 71 is such that the punch points 78 will produce a clearance spacing 160 between opposing punch points of about 1/16 inch (0.159 cm). FIG. 11 illustrates another example configuration of an overlapping condition of intentionally misaligned punch points 79. The punch points 79 on the circumferences of rotatable members 70 and 71 in FIG. 11 are elongated to produce a punch point overlap 162. Embodiments with rotatable members intentionally staggered transversely across the media conveyance path are possible whether or not the points overlap.

FIG. 12 illustrates an example punch point configuration. The deforming members typically have a generally tapering tip. In this example, a rotatable member body 164 has a pyramid shaped punch point 78 securely attached to it. This pyramid shaped region may be machined into the body of the rotatable member 164. The cross-section line 166 indicates the view plane of the section view of punch point punch sides 168 and 170. The punch point sides 168 and 170 can form a square cross-section at all cutting planes along the height of the pyramid shape region, creating edges that concentrate the punch forces and promote deeper punctures. This configuration of the deforming members can provide a good operational lifetime when composed of heat treated, mildly hard steel. By other approaches, the punch point cross-section need not be square with sides parallel and orthogonal to the media direction. For example, the cross-section may be rhomboidal to promote cutting with two acute edges and spreading with two obtuse edges parallel and orthogonal to the media direction.

FIG. 13 illustrates an example punch point configuration with unequal side lengths. The rotatable member body 172 in this example contains punch points 173 that have sides of unequal length. The punch point 173 may be machined into the rotatable member body 172 to provide a firm connection between them. The cross-section line 174 indicates the view plane of the section view of punch point sides 175, 177, 178, and 179. The punch point sides 177 and 179 may be of approximately equal lengths, and differ from sides 175 and 178 that are themselves of approximately equal lengths, thereby providing a rectangular cross-sectional shape. By another approach, a reduced cross-sectional area may be used with sides 175, 177, 178, and 179 all of unequal lengths. Preferably, the dimension encountering a stronger load in pushing the medium 1 through the media conveyance path 9 is the longer dimension. So configured, the unequal sides can provide an increased bending strength to the punch points in a desired direction and increase punch point life. In certain approaches, certain sides 176 of the punch points 173 can have the form of a concave (as shown in FIG. 13), convex, planar, or other predetermined surface shape that can alter the profile to affect cutting action or strength as desired. The cross-sectional profile may alternatively be a three sided wedge shape or a five or more sided object.

FIG. 14 illustrates an example punch point configuration with a circular cross-section 188 that can be replaced if wear or damage has occurred. For example, carbide punch points that are resistant to wear are also subject to breakage when encountering certain shape and hardness features as may occasionally occur in magnetic storage media. In this example, the rotatable member 180 contains threaded holes 183 that extend from the outer circumference into the rotatable member body 180. The punch point 182 has a male threaded base 184 that extends from the punch body, for example a stud bonded to carbide. The threaded base 184 may then threadingly engage the rotatable member 180 at the threaded holes 183. The cross-section line 186 indicates the view plane of the punch point 182 with a circular cross-sectional shape and conical profile. The base of the conical punch point 182 can be provided with flats to facilitate the loosening and tightening of the punch point 182 in the rotatable number 180. Accordingly, the deforming members can be removably secured to the rotatable member.

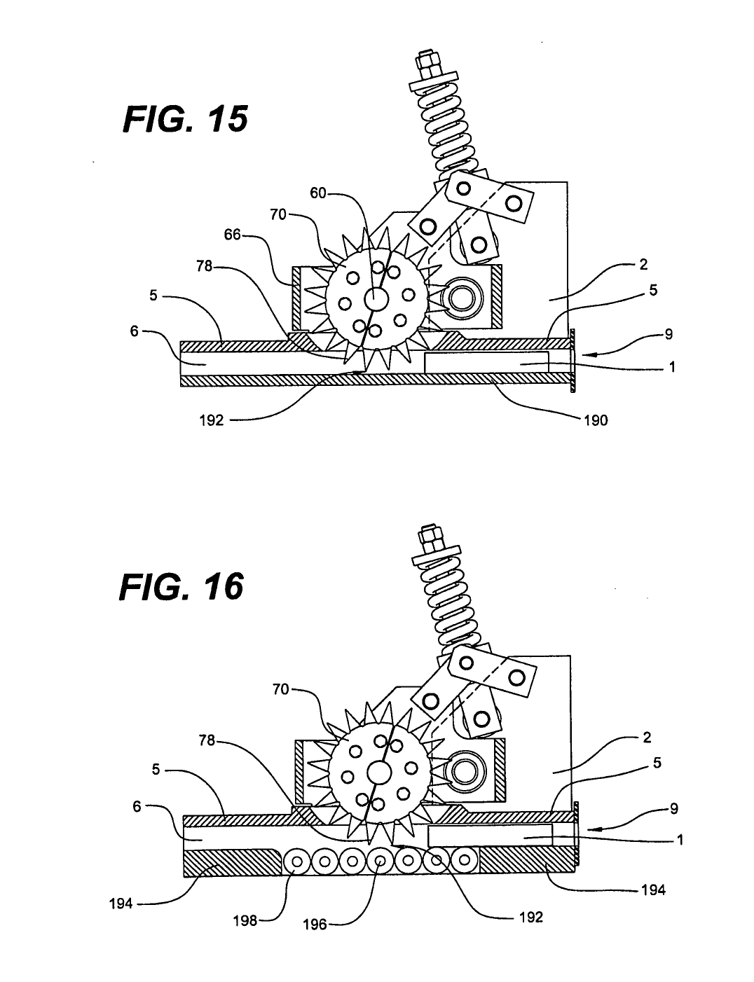

By another approach, deforming apparatuses may include only one biasing system and set of rotatable members as illustrated in FIGS. 15 and 16. FIG. 15 illustrates a one-sided configuration with a solid bottom surface 190. The embodiment requires only one rotatable member assembly and its related mechanical energy storage components, power transmission drive assembly and related support members. In that configuration, the torque imparted to the rotatable member 70 must overcome the frictional force between the medium 1 and bottom surface 190 as a result of the punch force exerted on medium 1.

FIG. 16 illustrates a one-sided configuration wherein the media conveyance path 9 includes at least one roller 198 to reduce the friction of the media passing through the device. The media passage bottom surface 194 in one such configuration is attached to the media passageway side surface 6. A series of low friction rollers 198 are placed in the media passageway bottom surface 194. The roller axels 196 are secured at each end to media passageway side surfaces 6 and 11. The roller axels 196 support the rollers 198 in a manner that allows them to freely rotate about their center axes. The bottom surface 194 may be contoured to facilitate the transfer of media onto rollers 198. The total number of rollers 198 required for each assembly and outside diameter of the roller is dependent on the size and type of magnetic storage media desired to be processed. If, for example, the mechanism were designed to process 1.8 inch (4.57 cm) format hard drive or smaller, then the total number of rollers 198 could be reduced and the outside diameter of the rollers may be ½ inch (1.27 cm) or less. It may also be desired when processing small media sizes to elongate the punch points 78 on the outer periphery of rotatable member 70 to produce a minimal clearance 192 between the tips of punch points 78 and the roller 198.

So configured, the deforming apparatus may be tailored to rapidly mark and/or destroy magnetic storage media of various sizes. The retractable pivot arm lessens the probability of jams, and the deforming members can mark a variety of media form factors.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. An apparatus for deforming media comprising:
a media conveyance path;
a pivot arm;
a biasing system operatively connected to the pivot arm that biases the pivot arm toward the media conveyance path;
at least one rotatable member rotatably secured to the pivot arm;
at least one deforming member secured to the at least one rotatable member such that the at least one deforming member is biased toward the media conveyance path to at least partially deform a medium passing through the media conveyance path; and
a driving apparatus operatively connected to the at least one rotatable member.

2. The apparatus of claim 1 wherein the media conveyance path comprises:
a media conveyance path top surface;
a media conveyance path bottom surface; and
media conveyance path side surfaces whereby the media conveyance path top surface, the media conveyance path bottom surface, and the media conveyance path side surfaces are spaced to be slightly larger than a medium to be deformed.

3. The apparatus of claim 1 wherein the media conveyance path comprises at least one roller.

4. The apparatus of claim 1 wherein the media conveyance path comprises an opening defined by a restrictor plate through which a medium to be deformed is passed wherein the opening is slightly larger than the medium to be deformed.

5. The apparatus of claim 1 wherein the biasing system comprises a compressed spring having a first spring end and a second spring end, the compressed spring disposed on a spring guide assembly;
wherein the spring guide assembly comprises:
a spring guide having a spring guide first end disposed toward the first spring end and a spring guide second end disposed toward the second spring end;
an adjustable spring retainer secured to the spring guide first end; and
a center pivot block slidably engaging the spring guide toward the spring guide second end and the second spring end.

6. The apparatus of claim 5 wherein the pivot arm is rotatably secured to a first pivot arm link and a chassis at least partially supporting the apparatus;
the first pivot arm link is rotatably secured to the center pivot block and a second pivot arm link; and
the spring guide assembly and the second pivot arm link are rotatably secured to the chassis such that the compressed spring biases the pivot arm toward the media conveyance path.

7. The apparatus of claim 1 wherein the biasing system comprises a spring operatively connected to the pivot arm and a chassis at least partially supporting the apparatus.

8. The apparatus of claim 1 wherein the biasing system comprises a hydraulic system.

9. The apparatus of claim 8 wherein the hydraulic system comprises a tank containing a fluid such that the pressure of the fluid is adjustable, and wherein the tank is in fluid communication with a piston operatively secured to a pivot block;
the pivot block rotatably secured to a first pivot arm link and a second pivot arm link;
the second pivot arm link being rotatably secured to a chassis at least partially supporting the apparatus; and
the first pivot arm link being rotatably connected to the pivot arm such that the hydraulic system biases the pivot arm toward the media conveyance path.

10. The apparatus of claim 1 further comprising a shock absorber operatively connected to the pivot arm and a chassis at least partially supporting the apparatus.

11. The apparatus of claim 1 wherein the deforming members are removably secured to the rotatable member.

12. The apparatus of claim 11 wherein the deforming members include a threaded base that threadingly engages the rotatable member.

13. The apparatus of claim 1 wherein the deforming members comprise a generally tapering tip.

14. The apparatus of claim 13 wherein the generally tapering tip comprises a cross-sectional shape of at least one of a group comprising:
rectangular;
square;
circular;
rhomboidal.

15. The apparatus of claim 13 wherein a least of portion of the generally tapering tip tapers in a manner including at least one of a group comprising:
concavely;
convexly;
planarly.

16. A method of deforming media comprising:
accepting a medium into a media conveyance path;
engaging the medium with a plurality of deforming members rotating on at least one rotatable member;
applying a deforming force to the medium through the deforming members via a biasing system;
allowing movement at least one of the rotating members away from the medium when the deforming members engage the medium and encounter an engaging force higher than the deforming force.

17. The method of claim 16 wherein the step of applying a deforming force to the medium through the deforming members via a biasing system further comprises applying the deforming force to the medium through the deforming members via a biasing system comprising an adjustable compressed spring assembly such that the deforming force is adjustable.
